(19) United States
(12) Patent Application Publication
(10) Pub. No.: US 2026/0134200 A1
(43) Pub. Date: May 14, 2026

(54) TERMINAL DEVICE, INFORMATION PROCESSING METHOD, AND NON-TRANSITORY COMPUTER-READABLE STORAGE MEDIUM

(71) Applicant: LegalOn Technologies, Inc., Tokyo (JP)

(72) Inventors: Ryoichi KOMAGAMINE, Tokyo (JP); Yuki YAMAKOSHI, Tokyo (JP); Yuki TAKAGI, Tokyo (JP); Takatsugu YONEYA, Tokyo (JP); Manabu NAKANO, Tokyo (JP)

(21) Appl. No.: 19/430,066

(22) Filed: Dec. 22, 2025

Related U.S. Application Data
(63) Continuation of application No. PCT/JP2024/022232, filed on Jun. 19, 2024.

(30) Foreign Application Priority Data
Jun. 23, 2023 (JP) 2023-103149

(51) Int. Cl. G06F 40/166; G06Q 50/18

(52) U.S. Cl. CPC G06F 40/166; G06Q 50/18

(57) ABSTRACT

Provided is a technique in which an operation load on a user is lighter than that in related art when document creation is supported on a web browser. A terminal device according to the present embodiment includes at least one processor. At least one processor gives editing information including name information to document information. The at least one processor switches the name information on an editing screen of the document information.

### CROSS-REFERENCE TO RELATED APPLICATIONS

This application is a continuation of International Application No. PCT/JP 2024/022232, filed on Jun. 19, 2024, the entire contents of which are incorporated herein by reference.

### TECHNICAL FIELD

Embodiments of the present disclosure relate to a terminal device, an information processing method, and a non-transitory computer-readable storage medium.

### RELATED ART

Conventionally, for example, there is a technique of giving editing information such as a correction history or a comment to an arbitrary position in a document in document creation software or the like. This editing information includes name information regarding who edited the document.

### SUMMARY

A terminal device according to an embodiment includes at least one processor. The at least one processor gives editing information including name information to document information, and switches the name information on an editing screen of the document information.

### BRIEF DESCRIPTION OF DRAWINGS

FIG. 1 is a schematic diagram for describing an outline of a document creation support system according to an embodiment;

FIG. 2 is a block diagram illustrating an example of a hardware configuration of an information processing device according to the embodiment;

FIG. 3 is a diagram illustrating an example of functional blocks in a processor of the information processing device of the present embodiment;

FIG. 4 is a block diagram illustrating an example of a hardware configuration of a terminal device according to the embodiment;

FIG. 5 is a diagram illustrating an example of functional blocks in a processor of the terminal device of the embodiment;

FIG. 6 is a diagram illustrating an example of a document review screen displayed on a display of the terminal device in document review processing according to the embodiment;

FIG. 7 is a diagram illustrating an example of a document editing screen displayed on a display of the terminal device in document editing processing according to the embodiment;

FIG. 8 is a flowchart illustrating a flow of document creation support processing according to the embodiment;

FIG. 9 is a diagram illustrating an example of a list of editor names pulled down by a click operation on a cursor disposed on a display area of name information according to the embodiment;

FIG. 10 is a diagram illustrating an example of an input area of an editor name when “+edit/add editor name” in FIG. 9 is pressed on a document editing screen according to the embodiment;

FIG. 11 is a diagram illustrating an example in which name information is changed from an editor name “Taro Henshu” illustrated in FIG. 7 to “LegalOn Legal Department” on a document editing screen according to the embodiment;

FIG. 12 is a diagram illustrating an example of an input area of a comment regarding a place where a character string is dragged by a cursor on a document editing screen according to the embodiment;

FIG. 13 is a diagram illustrating an example of a document review area when a comment is input on a document editing screen according to the embodiment;

FIG. 14 is a diagram illustrating a display example at a time point when a cursor is moved to an additional writing portion in a document editing area according to the embodiment; and

FIG. 15 is a flowchart illustrating a flow of document creation support processing according to Third Modification of the embodiment.

### DETAILED DESCRIPTION

Hereinafter, embodiments will be described in detail with reference to the drawings. Note that, in the following description, components having substantially the same functions and configurations may be denoted by the same reference signs, and description will be made if necessary. In addition, the embodiments can be combined with other embodiments, modifications, and conventional techniques.

At the time of document review like described in Related Art, it may be desired to change name information for various reasons. However, in conventional document creation software, various operations from environment setting or the like may be required in order to change the name information. That is, in conventional document creation software or the like, it may be difficult to flexibly change the name information.

One aspect of a problem to be solved by the present disclosure is to provide a technique in which an operation load on a user is lighter than that in related art.

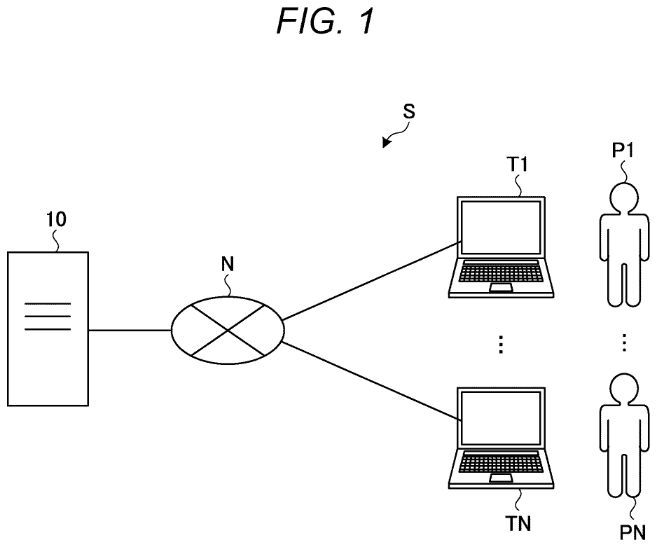

FIG. 1 is a schematic diagram for describing an outline of a document creation support system S according to the present embodiment. As illustrated in FIG. 1, the document creation support system S may function as a document creation support system, and include, for example, an information processing device 10 according to the embodiment and at least one of terminal devices T1 to TN capable of communicating with the information processing device 10 via a network N. The terminal devices T1 to TN may be operated by users P1 to PN, respectively. Note that the terminal devices T1 to TN will be described by taking a configuration of the terminal device T1 as an example.

The document creation support system S may be, for example, a system that supports document creation on a browser. In the present specification, a document may mean a document in any language, created according to a certain rule or standard such as a certain rule, law, or custom. In the present specification, document data may mean, for example, information obtained by converting a document into data in an editable manner in any data format. The document data may be typically text data, but can also include data such as image data or tabular data. In addition, the document or the document data may include meta-information (a version, a creation date, an update date, a creator, and an updater (may be referred to as an editor)), format information (a decoration such as an underline or a marker, a font, indent, and the like), change history information, comment information, chat information, and the like created by document creation software as necessary. In addition, the document or the document data may be referred to as document information.

Hereinafter, in order to make the description specific, a case where a document (which may be referred to as a support target document) handled by the document creation support system S is a legal document (for example, a contract document) in Japanese will be described as an example. However, the document handled by the document creation support system S may be a document other than a contract document, and may be described in a language other than Japanese. For example, the document handled by the document creation support system S may be an internal rule in English.

A document creation support service of the present embodiment can include, for example, at least any of: executing document review processing on a support target document on a web browser and providing a result thereof to a user; executing document editing in response to an instruction from the user; storing or providing an edited document to the user; editing additional information (for example, meta-information, comment information, chat information, or format information) associated with a support target document; creating a new document (including a copy); comparing a plurality of documents (for example, clearly indicating difference information); and automatically proofreading the support target document.

Note that, in the present specification, the document review processing may be processing of analyzing or evaluating information included in a support target document on the basis of a certain standard and outputting a result thereof. For example, the document review processing may include checking and examining whether or not information included in a support target document is appropriate on the basis of a certain standard. Specifically, the document review processing may include, for example, matching between wording in a document and a check list prepared in advance and outputting a result of matching or an indication included in the check list. In addition, editing may mean adding, deleting, or changing information included in an editing target.

The meta-information associated with the support target document may include, for example, at least one of a document ID, a type of document (for example, a type such as a basic transaction contract, a non-disclosure agreement, or a service agreement), a version, a creation date and time, an update date and time, an upload date and time, a creator, an updater, a deadline, and a document ID of a related document.

The comment information associated with the support target document of the present embodiment may be, for example, additional information created by at least one user related to creation of the document, and for example, may be associated and managed for each version of the support target document. The comment information associated with the support target document may be information different from a comment created by document creation software, and can include a comment created by the document creation software as necessary.

The chat information of the present embodiment may be, for example, additional information generated by using a chat function for a support target document among a plurality of users related to creation of the support target document, and for example, may be managed in association with a plurality of versions of the support target document. The additional information may be text data, and may also include another data format such as an image or voice.

The support target document of the present embodiment may be a document file uploaded from the terminal device T1, may be a file newly created on an online editor, or may be a file already uploaded, stored, and/or edited.

The terminal device T1 may be, for example, a client device managed by the user P1 who uses a document creation support service. The terminal device T1 of the present embodiment may display a document review result and editing data on a screen of a display device 30 on the basis of information from the information processing device 10. In the present embodiment, using a document review result and an editing screen displayed on a screen of the display device 30 of the terminal device T1, a user can perform operations such as document review reference, comment input, comment reference, chat information input, chat information reference, document editing processing, document storage, and addition/change of editor name for the support target document.

Next, specific configurations of the information processing device 10 and the terminal device T1 of the present embodiment will be described.

### Information Processing Device 10

The information processing device 10 of the present embodiment may be a device that is connected to a client device by communication and performs various types of processing in response to a request from the client device. The information processing device 10 may be, for example, a server device managed by a business operator that provides a document creation support service. For example, the information processing device 10 may provide a document creation support service to the terminal device T1 in response to a document creation support request received from the terminal device T1 as a client device via the network N. Specifically, the information processing device 10 of the present embodiment may execute document editing processing or provide information for executing the document editing processing to a client device in the document creation support service.

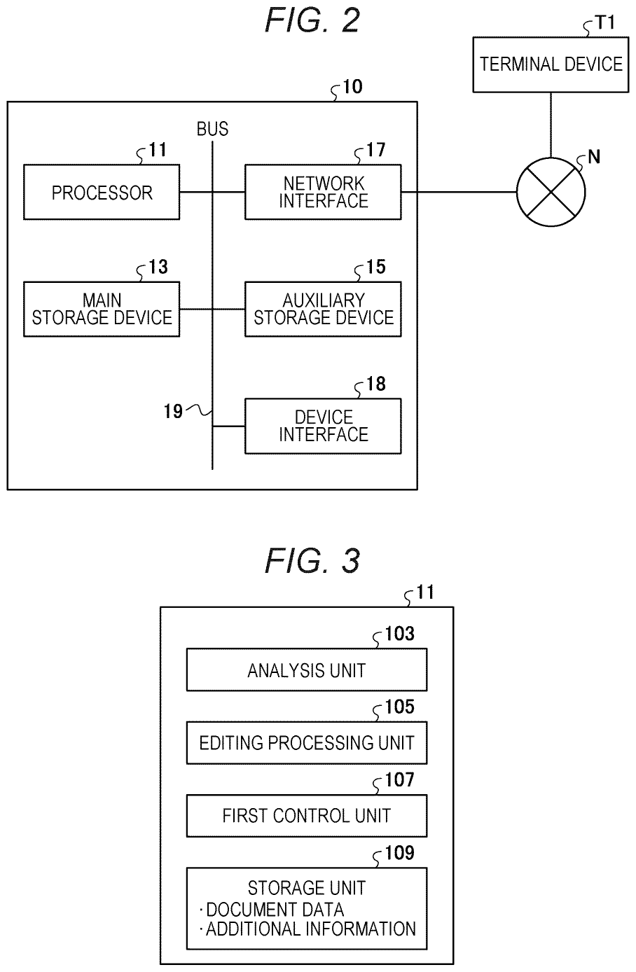

FIG. 2 is a block diagram illustrating an example of a hardware configuration of the information processing device 10 according to the embodiment. As illustrated in FIG. 2, the information processing device 10 may be a computer, and include, as an example, a processor 11, a main storage device (memory) 13, an auxiliary storage device (memory) 15, a network interface 17, a device interface 18, and a bus 19 that connects the components to each other.

The information processing device 10 illustrated in FIG. 2 includes each one component, but may include a plurality of the same components. In addition, one information processing device 10 is illustrated in FIG. 2, but software may be installed in a plurality of computers, and each of the plurality of computers may execute the same part or different parts of processing of the software. In this case, the information processing device 10 may be in a form of distributed computing in which each of the computers communicates via the network interface 17 or the like to execute processing. That is, the information processing device 10 in the present embodiment may be configured as a system that implements various functions described later by one or a plurality of computers executing commands stored in one or a plurality of storage devices. In addition, a part of processing may be performed by the terminal device T1.

Various computations of the information processing device 10 may be executed in parallel processing using one or a plurality of processors or using a plurality of computers via a network. In addition, various computations may be distributed to a plurality of computing cores in the processor and executed in parallel processing. In addition, a part or the whole of the processing, means, and the like of the present disclosure may be executed by at least one of a processor and a storage device provided on a cloud capable of communicating with the information processing device 10 via a network. As described above, the processing of the document creation support system S in the present embodiment may be in a form of parallel computing by one or a plurality of computers.

The processor 11 may be an electronic circuit (a processing circuit, a processing circuitry, a central processing unit (CPU), a graphics processing unit (GPU), a field programmable gate array (FPGA), an application specific integrated circuit (ASIC), or the like) including a control device and a computing device of the information processing device 10. In addition, the processor 11 may be a semiconductor device or the like including a dedicated processing circuit. The processor 11 may be achieved by an optical circuit using an optical logic element without being limited to an electronic circuit using an electronic logic element. In addition, the processor 11 may include a computing function based on quantum computing.

The processor 11 can perform computing processing on the basis of data and software (program) input from each device or the like of an internal configuration of the information processing device 10, and can output a computation result and a control signal to each device or the like. The processor 11 may control each component constituting the information processing device 10 by executing an operating system (OS) of the information processing device 10, an application, or the like.

The information processing device 10 in the present embodiment may be achieved by one or a plurality of processors 11. Here, the processor 11 may refer to one or a plurality of electronic circuits disposed on one chip, or may refer to one or a plurality of electronic circuits disposed on two or more chips or two or more devices. When a plurality of electronic circuits are used, the electronic circuits may communicate in a wired or wireless manner.

The main storage device 13 may be a storage device that stores commands executed by the processor 11, various types of data, and the like, and information stored in the main storage device 13 is read by the processor 11. The auxiliary storage device 15 may be a storage device other than the main storage device 13. Note that each of these storage devices may mean any electronic component capable of storing electronic information, and may be a semiconductor memory. The semiconductor memory may be either a volatile memory or a nonvolatile memory. A storage device for storing various types of data used in the information processing device 10 according to the present embodiment may be achieved by the main storage device 13 or the auxiliary storage device 15, or may be achieved by a built-in memory built in the processor 11. For example, a storage unit 109 in the present embodiment may be achieved by the main storage device 13 or the auxiliary storage device 15.

To one storage device (memory), a plurality of processors may be connected (coupled), or the single processor 11 may be connected. A plurality of storage devices (memories) may be connected (coupled) to one processor. When the information processing device 10 in the present embodiment includes at least one storage device (memory) and a plurality of processors connected (coupled) to the at least one storage device (memory), at least one processor among the plurality of processors may be connected (coupled) to the at least one storage device (memory). In addition, this configuration may be achieved by a storage device (memory) included in a plurality of computers and the processor 11. Furthermore, a storage device (memory) may be integrated with the processor 11 (for example, a cache memory including an L1 cache and an L2 cache).

The network interface 17 may be an interface for connecting to the network N in a wireless or wired manner. As the network interface 17, it may be required to use an appropriate interface such as one conforming to an existing communication standard. The network interface 17 may exchange information with an external device connected via the network N. Note that the network N may be any of a wide area network (WAN), a local area network (LAN), a personal area network (PAN), and the like, or may be a combination thereof, and may need to be one that allows exchange of information between the information processing device 10 and an external device. Examples of the WAN may include the Internet, examples of the LAN include IEEE802.11 and Ethernet (registered trademark), and examples of the PAN include Bluetooth (registered trademark) and near field communication (NFC).

The device interface 18 may be an interface such as a universal serial bus (USB) directly connected to an output device such as a display device, an input device, and an external device. In addition, the external device may be a storage such as a storage device (memory), a network storage, or an HDD. In addition, the external device may be a device having some functions of components of the information processing device 10 in the present embodiment. That is, the information processing device 10 may transmit or receive a part or the whole of a processing result of the external device.

FIG. 3 is a diagram illustrating an example of functional blocks in the processor 11. The processor 11 may include, for example, an analysis unit 103, an editing processing unit 105, a first control unit 107, and a storage unit 109 as functions implemented by the processor 11. Functions implemented by the analysis unit 103, the editing processing unit 105, the first control unit 107, and the storage unit 109 may be stored as programs in, for example, the main storage device 13 or the auxiliary storage device 15. By reading and executing a program stored in the main storage device 13, the auxiliary storage device 15, or the like, the processor 11 can implement functions related to the analysis unit 103, the editing processing unit 105, the first control unit 107, and the storage unit 109.

The analysis unit 103 of the present embodiment may execute document review processing using document data of a support target document (an example of first document data) received from the terminal device T1. That is, the analysis unit 103 of the present embodiment may generate document review information described later regarding the document data as the document review processing.

The analysis unit 103 may extract, for example, information included in a document (document data), for example, information necessary for generating document review information. Various techniques can be adopted as a method for extracting information from the document data. For example, keyword search of the document data may be performed, and a character, a number, and the like included in the vicinity of the keyword may be extracted. In addition, information can also be extracted by morphological analysis, syntax analysis, semantic analysis, or context analysis. Furthermore, information may be extracted by natural language processing using machine learning. In addition, prior to the processing, information necessary for document review, such as text data, may be extracted from received document data, or processing of extracting text data from image data may be performed by processing such as OCR. Note that the document review processing may be performed on the received document without extracting information necessary for generating the document review information as described above.

The analysis unit 103 of the present embodiment may perform document review processing to generate document review information. The document review information may be based on, for example, information obtained by analyzing a document on the basis of a rule or a standard applied to the document (for example, a certain rule, law, or custom). Examples of review information of a contract document as in the present embodiment may include: (1) an indication as to whether an article included in a document (a contract document in the present embodiment) is advantageous or disadvantageous to a user (party); (2) an advice regarding correction and deletion of the article included in the contract document; (3) an indication that an item that should be usually included in the contract document is missing, and suggestion of an item to be added; and (4) information on the importance and the degree of recommendation of an item of each review result. By using the above information, a user can easily perform grasping of a legal risk included in the contract document and contract review response including correction proposal. In addition, format information indicating, for example, whether a format of a sentence meets a standard, and whether a prescribed term is used may also be included.

Note that the generation of the document review information executed by the analysis unit 103 can adopt various techniques. For example, the document review information may be generated on a rule basis using the extracted information. In addition, it is also possible to use a learned model that receives document information or the extracted information as an input and outputs corresponding document review information. Furthermore, it is also possible to adopt a combination of a rule-based method and a learned model. In addition, before the generation of the document review information, the document may be divided into sections, paragraphs, items, and the like in units.

In addition, the analysis unit 103 can generate document review information according to a position of a user (party) by using meta-information associated with the support target document. Furthermore, the analysis unit 103 can also generate the document review information by referring to a content of another document (another version of the support target document, another contract document relevant to the support target document, and the like). The meta-information may include information given to a document file itself of a creator or the like of the document and information given by a user or the like by being input separately from the file.

The editing processing unit 105 of the present embodiment may convert a data format of the support target document (document data) received via the first control unit 107 to generate editing data. The editing data may be referred to as editing information. For example, the editing processing unit 105 may convert document data in a “DOCX” format received via the first control unit 107 into a “JSON” format to generate editing data.

In addition, the editing processing unit 105 of the present embodiment may execute editing processing on the editing data in response to an editing instruction received from the terminal device T1 via the first control unit 107. Here, the editing processing executed by the editing processing unit 105 may include adding, deleting, and changing information included in the editing data. More specifically, the editing processing may include adding, correcting, and deleting a word, a sentence, and a character decoration (for example, a font, a color of a character, a size of a character, a thickness of a character, an underline, or a strikethrough) with respect to the editing data.

In addition, the editing processing executed by the editing processing unit 105 can include format editing processing, word input assisting processing, draft suggesting processing, indicated matter extraction processing, and difference information extraction processing.

Here, the format editing processing may be, for example, processing of correcting a format of editing data as a document. For example, indent, a line head of itemized writing, right-alignment/left-alignment, deviation of an article number, and the like may be preferably automatically corrected with a system by the format editing processing. For example, the editing processing unit 105 may refer to format information of the support target document corresponding to the editing data, and execute format editing processing on the editing data on the basis of the format information. In addition, setting of a format as a document may be preferably stored in advance in the information processing device 10, the terminal device T1, or the like on the basis of the type of the support target document such as a contract document. For example, in a case of a legal document such as a contract document or an internal rule, setting may be performed such that sections, paragraphs, and items are arranged in this order and in an ascending order of article numbers, and indent is larger in order of sections, paragraphs, and items. In addition, the editing processing unit 105 can execute format editing processing according to a type on the basis of the meta-information of the support target document. Note that this format setting may be created by a user, may be provided as a part of the document creation support service, or may be created by the user customizing the provided setting. In addition, format setting of the support target document may be interpreted, and may be created on the basis of the interpretation.

The word input assisting processing of the present embodiment may be processing of assisting input, for example, by presenting a candidate word or phrase to be input next at the time of editing document data. As a result, it is possible to support user's input operation at the time of editing and to reduce a work load. For example, a word or the like that frequently appears can be presented as an input candidate according to the type of the support target document. In addition, the support target document stored by a user or an organization to which the user belongs may be analyzed, and a word or the like that is often used may be presented. In addition, a user may set a word or a phrase. The editing processing unit 105 can determine an input candidate word according to a type on the basis of the meta-information of the support target document. A word or the like presented in the input assisting processing may be displayed, for example, in a left window (in a document editing window) of a screen described later.

The draft suggesting processing of the present embodiment may be processing of displaying a draft of an input candidate at the time of editing. For example, when the document is a contract document, a correction sentence example based on at least a part of a correction content of the contract document may be read from a database in which a provision draft example is accumulated and presented as a draft candidate. As a result, it is possible to support user's input operation at the time of editing and to reduce a work load.

The editing processing unit 105 may present a predetermined draft candidate, may present a draft candidate determined by a user or a provider of the document creation support service, may present a draft candidate generated by a sentence generation service inside or outside the present system using a large language model (LLM) or the like, or may present a draft candidate frequently appearing according to the type of the support target document. In addition, a support target document stored by a user or an organization to which the user belongs may be analyzed, and a draft candidate more frequently used than other documents may be presented. When there are a plurality of draft candidates, at least one draft candidate can be further selected on the basis of an adoption ratio of a provision (a ratio at which a proposed provision is selected by a user) and an adoption frequency in the past document creation support service, and a candidate with a higher adoption ratio can be preferentially presented to the user. Note that the draft candidate to be presented can be presented as, for example, the document review information or other information.

The editing processing unit 105 can also edit the editing data in response to the editing instruction based on the presented draft candidate, for example, an instruction by a drag-and-drop operation. The proposed draft may be displayed in a document review area or the like described later while being associated with a corresponding portion of the document in position. For example, the draft candidate may be displayed close to a corresponding portion of the document. With such display, it is possible to compare the draft candidate and the corresponding portion of the document with less movement of a line of sight, and it is possible to reduce a load on a user.

The indicated matter extraction processing of the present embodiment may be, for example, processing of extracting an indicated matter (for example, document review information, comment information, and chat information about document data corresponding to editing data, a correction history for the editing data, or a comment on document data created by a function of document creation software) related to at least one of editing data and document data corresponding to the editing data, and presenting the indicated matter to a user. The editing processing unit 105 of the present embodiment may present the extracted indicated matter to a user in a predetermined display form. The indicated matter may be preferably displayed as a list in an area that does not overlap with a portion of the document indicated by the indicated matter, for example, a document review area 62 displayed side by side with an editing area or an independent (individual) window such as a pop-up window.

In addition, by a combination of the indicated matter extraction processing and the draft suggesting processing, the indicated matter and a draft candidate that can resolve the indicated matter may be proposed. At this time, the indicated matter and the draft candidate may be preferably displayed in association with an indicated portion of the document in position. For example, the indicated matter and the draft candidate may be preferably displayed close to a corresponding indicated matter. With such display, it is possible to compare the indicated matter, the draft candidate, and the corresponding portion of the document with less movement of a line of sight, and it is possible to reduce a load on a user.

In addition, for the document review area 62, a pop-up window, and the like in which the indicated matter and the draft candidate may be displayed, folding display, minimization display, change in display size, and the like can be executed. As a result, a user can arrange a document editing screen having a limited size such that the user can easily see the document editing screen, for example, by aligning the document editing screen with the indicated portion of the document. In addition, on the basis of the height of the indicated matter or the draft candidate, provisions may be displayed at a wider interval in an editing area. With such display, it is possible to more clearly and simply indicate a correspondence relationship among the indicated matter, the draft candidate, and the indicated portion of the document.

The difference information extraction processing of the present embodiment may present difference information between two pieces of document data, for example, the support target document data before correction and the corrected document data to a user. For example, the editing processing unit 105 of the present embodiment may extract difference information from editing data before correction and corrected editing data, and may present the difference information to a user in a predetermined display form, for example, by displaying the difference and the other portion (that is, the same portion) differently, for example, by emphasis display or highlighting.

The editing processing unit 105 of the present embodiment may execute the above-described various types of editing processing, for example, in response to an editing instruction received from the terminal device T1. In addition, the editing processing unit 105 of the present embodiment may convert a data format of the editing data in response to a storage instruction received from the terminal device T1 to generate document data to be a next version of the support target document. For example, in response to a storage instruction received from the terminal device T1, the editing processing unit 105 may convert the data format of the editing data to a “JSON” format to generate document data (an example of second document data) in a “DOCX” format to be a next version of the support target document.

The first control unit 107 may perform, for example, information communication with the terminal device T1 via the network N. Specifically, the first control unit 107 may receive document data transmitted from the terminal device T1 and various instructions such as a document review instruction, an editing instruction, and a storage instruction. In addition, the first control unit 107 may transmit editing screen information (including information for executing document editing processing on a terminal device T1 side) to the terminal device T1. The first control unit 107 may receive information including document data after editing processing from the terminal device T1.

The first control unit 107 of the present embodiment may generate layout information in the document review processing and the document editing processing. Here, the layout information in the document review processing may be, for example, information for displaying document review information generated by document review processing and a support target document in association with each other in position in a predetermined form on a browser screen of the terminal device T1. In addition, the layout information in the document editing processing may be, for example, information for displaying document review information generated by document review processing and editing data generated by document editing processing in association with each other in position in a predetermined form on a browser screen of the terminal device T1.

Note that the mutual association in position may refer to, for example, associating positions to be displayed so as to be browsed by a user, and may specifically mean associating the positions on a screen, for example, in units of articles, in units of paragraphs, or in units of sentences. Associating the positions may include, for example, displaying corresponding portions closer to each other in a height or width direction than the other portions, and more preferably, displaying the corresponding portions side by side on a screen. In addition, when additional information is displayed together, the layout information may include information for associating the additional information with the document review information and the editing data in position. In the additional information included in the layout information, a name of an editor (editor name) in the meta-information may be an example of name information.

The layout information may be generated by any method. For a word or a phrase included in the document review information, the degree of coincidence may be scored for each position (for example, each position in units of articles or each position in units of paragraphs) in editing data by a search function, and the layout information may be generated such that the document review information is displayed corresponding to a position with the highest score. In addition, for example, by assigning coordinates in units of articles or in units of paragraphs of editing data and associating the coordinates with corresponding document review information, it is also possible to associate the display positions of the articles and the paragraphs with the display positions of the document review information.

The first control unit 107 of the present embodiment may transmit various types of information such as document review information generated by the analysis unit 103, editing data generated by the editing processing unit 105, and layout information generated by the first control unit 107 in response to a request from the terminal device T1. In addition, the first control unit 107 of the present embodiment may transmit editing screen information (including information for executing editing processing on the terminal device T1 side) to the terminal device T1, and may receive information including document data after the editing processing from the terminal device T1.

The storage unit 109 may store document data uploaded from the terminal device T1, document data of a new version generated from editing data by document editing processing, additional information associated with each piece of document data, and the like.

### Terminal Device T1

The terminal device T1 of the present embodiment may transmit and receive information regarding document display and document editing to and from the information processing device 10 in a document creation support service. Note that a part or the whole of the processing performed by the information processing device 10 in the present embodiment may be performed by the terminal device T1.

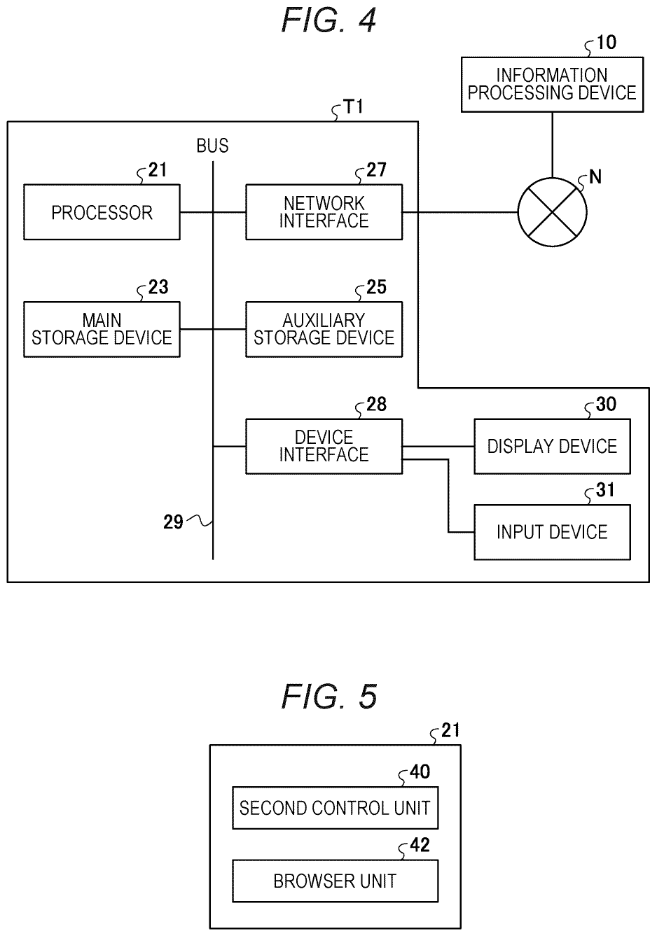

FIG. 4 is a block diagram illustrating an example of a hardware configuration of the terminal device T1 according to the embodiment. As illustrated in FIG. 4, the terminal device T1 may be a computer, and include, as an example, a processor 21, a main storage device (memory) 23, an auxiliary storage device (memory) 25, a network interface 27, a device interface 28, a bus 29 that connects the components to each other, a display device 30 connected to the device interface 28, and an input device 31 connected to the device interface 28. Note that specific hardware configurations of the processor 21, the main storage device 23, the auxiliary storage device 25, the network interface 27, the device interface 28, and the bus 29 are similar to those of the processor 11, the main storage device 13, the auxiliary storage device 15, the network interface 17, the device interface 18, and the bus 19, respectively, and therefore description thereof is omitted.

The display device 30 may be a display device such as a liquid crystal display (LCD), a cathode ray tube (CRT), a plasma display panel (PDP), or an organic electro luminescence (EL) panel. The display device 30 may display, for example, a document review screen and a document editing screen described later on the basis of an instruction from the processor 21. Note that the sentence editing screen may be simply referred to as an editing screen.

The input device 31 may be a device such as a keyboard, a mouse, or a touch panel. A user can input various editing instructions, for example, in document editing processing described later using the input device 31. The instruction input from the input device 31 may be sent to the processor 21.

Note that the terminal device T1 may include another external device (for example, a camera, a microphone, a motion capture, or various sensors) connected via the device interface 18 in order to operate and edit document data.

FIG. 5 is a diagram illustrating an example of functional blocks in the processor 21. The processor 21 may include, for example, a second control unit 40 and a browser unit 42 as functions implemented by the processor 21. Functions implemented by the second control unit 40 and the browser unit 42 may be stored, for example, as programs in, for example, the main storage device 23 or the auxiliary storage device 25. By reading and executing a program stored in the main storage device 23, the auxiliary storage device 25, or the like, the processor 21 can implement functions related to the second control unit 40 and the browser unit 42.

For example, the second control unit 40 may activate the browser unit 42 in response to an instruction from a user. In the present embodiment, a document is browsed or edited by the browser unit 42.

The browser unit 42 may be, for example, a general web browser, and executes processing according to hyper text markup language (HTML) data, a script (for example, JavaScript (registered trademark)), or the like. When being activated, the browser unit 42 may transmit an initial access URL to the information processing device 10 to make access.

The browser unit 42 of the present embodiment may display data including text data and image data received from the information processing device 10 on the display device 30 of the terminal device T1 in a predetermined form. More specifically, in the document review processing, the browser unit 42 of the present embodiment may display document review information, document data, additional information, and the like received from the information processing device 10 on the display device 30 of the terminal device T1 in a predetermined form on the basis of layout information, and receive editing screen information (including information for executing document editing processing) from the first control unit 107. In addition, the browser unit 42 of the present embodiment may receive editing screen information (including information for executing editing processing) from the first control unit 107, and execute the editing processing. As a result, the browser unit 42 can generate editing information (editing data) by associating an edited content edited on the editing screen by an instruction of a user for a document to be edited on the editing screen with an editor name (name information) at the time of inputting the edited content. In the document editing processing, the browser unit 42 of the present embodiment may display document review information, editing data, additional information, and the like received from the information processing device 10 on the display device 30 of the terminal device T1 in a predetermined form on the basis of layout information.

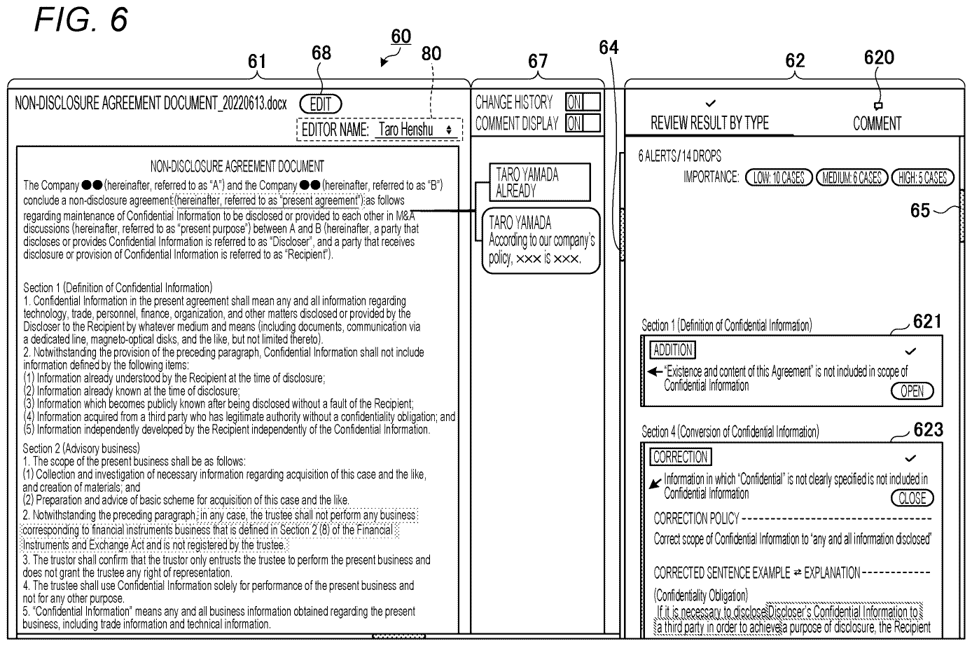

FIG. 6 is a diagram illustrating an example of a document review screen 60 displayed as a web browser screen on the display device 30 of the terminal device T1 in document review processing. As illustrated in FIG. 6, on the document review screen 60 of the present embodiment, the support target document is displayed in a document display area 61, the additional information such as a change history and a comment may be displayed in an additional information area 67, and the document review information may be displayed in a document review area 62.

For example, in the document display area 61, a scroll bar 64 for scrolling the support target document displayed in the document display area 61 and the additional information displayed in the additional information area 67 in the vertical direction may be displayed next to the additional information area 67 where the additional information is displayed.

In addition, for example, in the document review area 62 in which the document review information is displayed, a comment button 620 for instructing comment input as the additional information, and comments 621 and 623 as the document review information may be displayed so as to correspond to target articles of the support target document in position.

More specifically, in the present embodiment, the comment 621 serving as document review information for a certain article of the support target document, which is “Section 1 (Definition of Confidential Information)” in the example of FIG. 6, may be displayed so as to be closer to “Section 1 (Definition of Confidential Information)” of the support target document than other articles in position in a screen height direction. In addition, the additional information (a change history and a comment in FIG. 6) may be displayed so as to correspond to a target portion “main purpose” of the support target document in position in the screen height direction.

Note that the association of positions among the support target document displayed in the document display area 61, the additional information displayed in the additional information area 67, and the document review information displayed in the document review area 62 may be temporary. For example, in a state where the support target document, the additional information, and the document review information are not associated with each other in position, and are displayed in the document display area 61, the additional information area 67, and the document review area 62, respectively, for example, in response to a predetermined operation such as inserting a cursor into a provision of the support target document and clicking the vicinity of the provision, position association display among the support target document, the additional information, and the document review information may be executed with the position of the provision as reference. In addition, the position association display among the support target document, the additional information, and the document review information can be released by a predetermined operation.

In addition, in the document review screen 60 of the present embodiment illustrated in FIG. 6, for example, when the support target document (and the additional information displayed in the additional information area 67) displayed in the document display area 61 is scrolled in the vertical direction by the scroll bar 64, in conjunction with this, the document review information displayed in the document review area 62 may be also scrolled in the vertical direction while maintaining a display positional relationship with the support target document. Conversely, for example, when the document review information displayed in the document review area 62 is scrolled in the vertical direction by a scroll bar 65, in conjunction with this, the support target document (and the additional information displayed in the additional information area 67) displayed in the document display area 61 may be also scrolled in the vertical direction while maintaining a display positional relationship with the document review information.

In addition, the document review information may include information indicating a level of importance of the review result in stages. In addition, for example, as characters of “importance” and numbers are displayed in an upper part of the document review area 62, the number of indication results may be indicated for each level of importance.

While referring to the document review information and the additional information displayed on the document review screen, a user can easily examine what kind of indication matter is in the support target document, how to correct the document, and the like.

In addition, as illustrated in FIG. 6, an edit button 68 for instructing start of document editing processing may be displayed on the document review screen of the present embodiment. A user can start the document editing processing by operating the edit button 68. In addition, as illustrated in FIG. 6, on a sentence review screen, an editor name (name information) who has input a change history, a comment, and the like may be displayed in a name information display area (hereinafter, referred to as a name display area) 80. The editor name (name information) can be added and/or selected appropriately by an input operation on the name display area 80. When the editor name (name information) is changed and selected by the input operation on the name display area 80, additional information associated with the editor name may be displayed by being switched according to the selected editor name. Note that the document editing processing may be started in a state where the document display area 61 may be displayed. That is, in response to display of a document review screen, a state in which the document editing processing can be executed may be achieved.

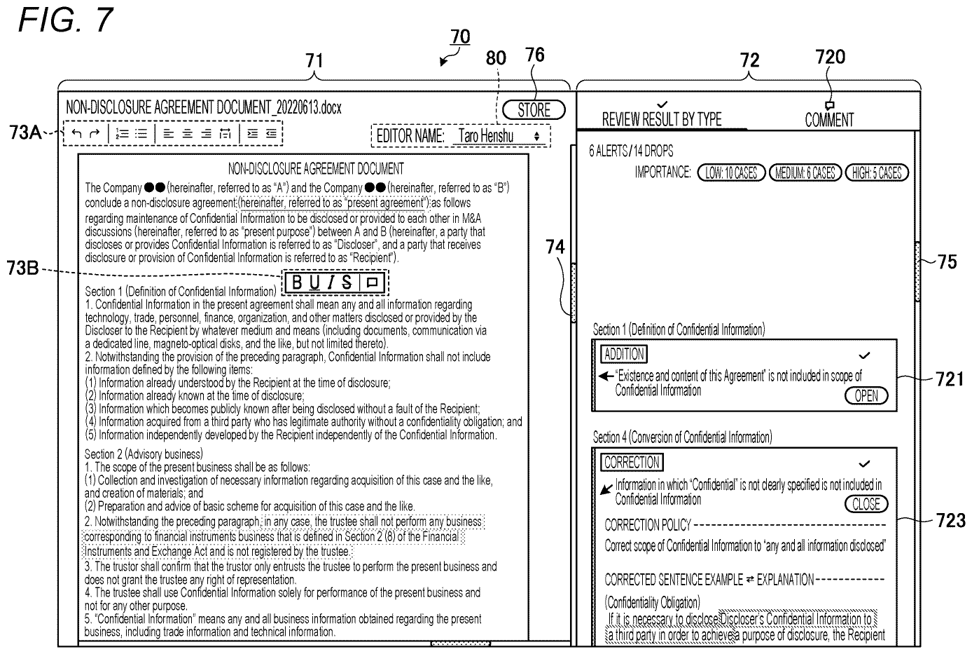

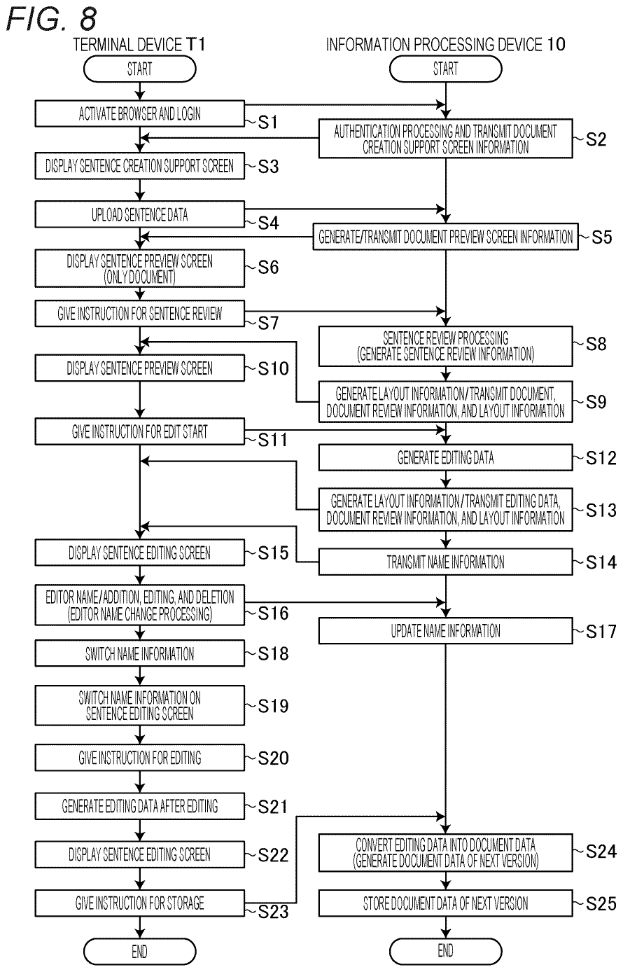

FIG. 7 is a diagram illustrating an example of a document editing screen 70 displayed as a web browser screen on the display device 30 of the terminal device T1 in document editing processing of the present embodiment In the document editing screen 70 illustrated in FIG. 7, for example, a web browser screen may be displayed by being switched by operating the edit button 68 on the document review screen 60 illustrated in FIG. 6.

As illustrated in FIG. 7, on the document editing screen 70 of the present embodiment, editing data may be displayed in a document editing area 71, and document review information may be displayed in a document review area 72. Since the editing data displayed in the document editing area 71 of FIG. 7 is obtained by converting the data format of the support target document, a content thereof may be the same as that of the support target document displayed in the document display area 61 of FIG. 6. In addition, a comment button 720, comments 721 and 723 as the document review information, and a scroll bar 75 included in the document review area 72 may be the same as the comment button 620 and the like included in the document review area 62 of FIG. 6 because a content of the document is similar. Note that, although FIG. 7 illustrates a case where the additional information is hidden, the additional information can be displayed, for example, in a form similar to FIG. 6 by setting the document editing screen 70. In addition, as illustrated in FIG. 7, on the sentence editing screen of the present embodiment, an editor name (name information) who has input a comment or the like may be displayed in the name display area 80 as on the document review screen. When the editor name (name information) is changed and selected by an input operation on the name display area 80, various types of editing work can be performed with the selected editor name.

For example, by processing such as directly inputting, deleting, and pasting characters to the editing data displayed in the document editing area 71, a user can edit the editing data. In addition, on the document editing screen 70, tool bars 73A and 73B including buttons for inputting various editing instructions may be displayed in the document editing area 71 in which the editing data is displayed. For example, a user can execute editing of the format of the editing data, character decoration, and comment insertion by operating a desired editing instruction button of the tool bars 73A and 73B.

When a draft candidate for supporting correction is displayed as document review information in the document review area 72 of the document editing screen 70 of the present embodiment, a user can edit the editing data by adding the draft candidate to the editing data in the document editing area 71 by cut-and-paste processing, drag-and-drop processing, or the like. In addition, a draft candidate for supporting correction does not have to be separately displayed, and the editing data in the document editing area 71 may be directly replaced with a corrected draft or rewritten.

In addition, on the document editing screen 70 of the present embodiment, a storage button 76 may be displayed in the document editing area 71 in which the editing data is displayed. A user can instruct storage of the edited editing data by operating the storage button 76. Note that storage may be performed automatically or without an instruction of a user, in addition to the storage instruction of the user. In addition, the stored data may be stored as another new version of the support target document, or may be overwritten and stored as the same version as the support target document.

### Flow of Document Creation Support Processing

Next, an example of document creation support processing implemented by the information processing device 10 according to the embodiment will be described. The present document creation support processing may include structure optimization processing in which a plurality of calculation algorithms are switched and used according to a situation. FIG. 8 is a flowchart illustrating a flow of the document creation support processing according to the present embodiment.

### Step S1

The second control unit 40 of the terminal device T1 of the present embodiment may activate the browser unit 42 in response to an instruction from a user. The browser unit 42 of the terminal device T1 may transmit, for example, login information such as an initial access URL or a registration ID to the information processing device 10.

### Step S2

The first control unit 107 of the information processing device 10 of the present embodiment may execute authentication processing in response to the login information from the terminal device T1. In addition, the first control unit 107 may transmit document creation support screen information generated by the first control unit 107.

### Step S3

The browser unit 42 of the terminal device T1 of the present embodiment may display a document creation support screen on the display device 30 on the basis of the document creation support screen information received from the information processing device 10.

### Step S4

The browser unit 42 of the terminal device T1 of the present embodiment may transmit support target document data to the information processing device 10 in response to a document upload instruction from the user. This upload instruction may be performed by a user who gives a review instruction, or may be performed by a different user or/and a terminal device. For example, the upload instruction may be performed by a terminal device of a user of another department that requests a legal department to examine a contract document. In addition, the support target document data may be uploaded without intervention of the browser unit 42.

### Step S5

The first control unit 107 of the information processing device 10 of the present embodiment may store the document data received from the terminal device T1 in the storage unit 109, and generate document preview screen information on the basis of the received document data. The first control unit 107 of the information processing device 10 of the present embodiment may transmit the generated document preview screen information to the terminal device T1 Note that the document upload instruction and the storage of the document data in the storage unit 109 may be performed, for example, by another user and/or another terminal device of another department that requests a legal department to examine a contract document prior to editing processing. The analysis unit 103 of the information processing device 10 of the present embodiment may analyze the document data stored in the storage unit 109 and extract information or the like necessary for document review processing described later.

### Step S6

The browser unit 42 of the terminal device T1 of the present embodiment may display a document preview screen on the basis of the document preview screen information received from the information processing device 10. Note that, at this stage, since document review processing has not been performed, for example, only the support target document is displayed on the document preview screen. Note that by executing this step S6, the document creation support system S of the present embodiment can be used not only for editing a document but also for browsing a document.

### Step S7

The browser unit 42 of the terminal device T1 of the present embodiment may transmit a document review instruction input from the user to the information processing device 10.

### Step S8

The analysis unit 103 of the information processing device 10 of the present embodiment may execute document review processing in response to the document review instruction from the terminal device T1 to generate document review information. Note that this document review processing may be performed after the document data received from the terminal device T1 is stored in the storage unit 109 (step S5) and before the document data is displayed. In addition, the review processing may be executed regardless of the document review instruction from the terminal device T1.

### Step S9

The first control unit 107 of the information processing device 10 of the present embodiment may generate layout information for displaying the document review information in association with the support target document. The first control unit 107 of the information processing device 10 of the present embodiment may transmit the document data of the support target document, the document review information generated by the analysis unit 103, and the layout information generated by the first control unit 107 to the terminal device T1

### Step S10

The browser unit 42 of the terminal device T1 of the present embodiment may display a document review screen on the basis of the document data, the document review information, and the layout information received from the information processing device 10. Note that, on this document review screen, for example, the document review information and the document as illustrated in FIG. 6 may be displayed in a form in which positions thereof are associated with each other. At this time, in the present embodiment, as illustrated in FIG. 6, a user name at the time of login may be displayed in the name display area 80 as an editor name. Note that an editor name at the time of previous editing of the document data may be displayed in the name display area 80. As described above, the second control unit 40 of the terminal device T1 may cause the display device 30 to display an editor name used in the previous editing operation or a user name on an editing screen as default name information.

### Step S11

The browser unit 42 of the terminal device T1 of the present embodiment may transmit an editing start instruction (for example, an instruction by operation of the edit button 68 illustrated in FIG. 7) input from the user to the information processing device 10.

### Step S12

The editing processing unit 105 of the information processing device 10 of the present embodiment may convert the data format of the document data in response to the editing start instruction from the terminal device T1 to generate editing data. Note that the editing data may be generated and stored before the editing start instruction from the terminal device T1.

### Step S13

The first control unit 107 of the information processing device 10 may generate layout information for displaying the editing data and the document review information in association with each other. The first control unit 107 of the information processing device 10 may transmit the editing data, the document review information, the layout information, and the information for executing the document editing processing to the terminal device T1.

### Step S14

The first control unit 107 of the information processing device 10 of the present embodiment may transmit the name information to the terminal device T1 The first control unit 107 may transmit, for example, a user name at the time of login to the terminal device T1 as the name information. Note that the “user name” and the “name information” indicating an individual do not have to be related to each other. For example, a local storage of the browser unit 42 of the terminal device T1 may hold information indicating which number of editor name is selected among a plurality of editor names in the registered name information. The second control unit 40 may switch the selected name information by using, for example, a list of the registered name information transmitted from the information processing device 10 and data indicating the number of name information stored in the local storage of the browser unit 42 of the terminal device T1. As a result, the browser unit 42 can execute, for example, switching of the editor name in the name information. Note that the first control unit 107 may transmit the editor name used in the previous editing operation to the terminal device T1 as the name information. In the following processing, the terminal device T1 of the present embodiment may use data of the name information transmitted from the information processing device 10.

### Step S15

The browser unit 42 of the terminal device T1 of the present embodiment may display the document editing screen 70 on the basis of the editing data, the document review information, the layout information, the information for executing the document editing processing, and the name information received from the information processing device 10. Note that, on the document editing screen 70 of the present embodiment, for example, the document review information and the editing data as illustrated in FIG. 7 may be displayed in a form in which positions thereof are associated with each other. In FIGS. 6 and 7, the name information is displayed as “Taro Henshu” as a login user name.

### Step S16

The browser unit 42 of the terminal device T1 of the present embodiment can execute processing related to selection, addition, editing, and deletion (also referred to as editor name change processing) regarding the editor name included in the name information according to an instruction of the user via the input device 31. When the processing of addition, editing, and deletion is executed on the name information, the terminal device T1 may transmit second name information on which addition, editing, and deletion have been performed to the information processing device 10.

The “selection” executed by the browser unit 42 of the present embodiment may be, for example, processing of selecting either an editor name or an original user name registered in the name information in advance as an editor name to be used by the user according to an instruction of the user via the input device 31. After the selection, the browser unit 42 may change the editor name on the sentence editing screen to the selected editor name as an editor name related to execution of a subsequent editing instruction. For example, the editing processing unit 105 on which the operation of “selection” has been performed may update information of “which number of editor name is used” in the name information stored in the memory.

The “editing” executed by the browser unit 42 of the present embodiment may be, for example, processing of changing the registered editor name registered in the name information in advance according to an instruction of the user via the input device 31. That is, the “editing” may be processing of changing the editor name according to a desire of the user.

The “addition” executed by the browser unit 42 of the present embodiment may be processing of newly adding an editor name to the name information according to an instruction of the user via the input device 31. The addition of the editor name may be implemented by inputting a new editor name according to an instruction of the user via the input device 31.

The “deletion” executed by the browser unit 42 of the present embodiment may be processing of deleting the editor name registered in the name information according to an instruction of the user via the input device 31.

Note that such setting of information regarding an editor name including addition, editing, and deletion of the editor name may be referred to as editor name editing processing. In addition, among the four operations (selection, addition, editing, and deletion), only “selection” may be implemented by a different user interface. The different user interface may be, for example, a display of displaying a list of “a plurality of editor names” in the name information and enabling selection of (for example, display of a pull-down list). As a result, even when a plurality of editor names are registered, selection of an editor name can be performed easily.

Note that the editor name may be selected and changed without an instruction of a user. For example, a user may perform setting such that editing information for the inside of the company and editing information for the outside of the company can be distinguished from each other, or a document editing support system distinguishes the editing information for the inside of the company and the editing information for the outside of the company from each other, whereby the editor name may be switched. In addition, the editor name may be switched according to a role of the user who uses the terminal device T1. For example, the editor name may be switched between a case where the editor is a primary reviewer or a creator of a document and a case where the editor is a secondary reviewer who approves an examined or created document. This can be achieved, for example, by determining or setting whether a hyperlink for displaying a document is set and the link indicates a secondary review request.

In addition, it may have a function of changing the already set editor name of the editing information to an editor name included in the name information. As a result, even when editing information having an editor name is given by other document editing software or the like, an appropriate editor name can be obtained.

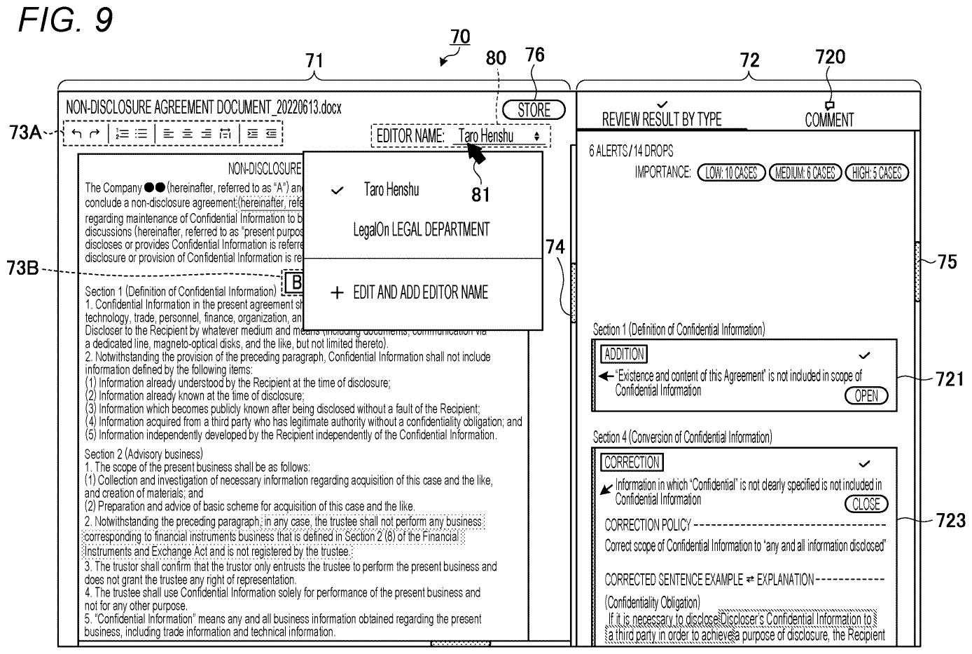

FIG. 9 is a diagram illustrating an example of a list 82 of editor names pulled down by a click operation on a cursor 81 disposed on the display area 80 of the name information. For example, when a + sign “edit/add editor name” is pressed by the cursor 81 in the list 82 of editor names illustrated in FIG. 9, the editor name can be edited, added, or deleted. A check symbol in the list 82 of editor names in the example illustrated in FIG. 9 may indicate a currently selected editor name.

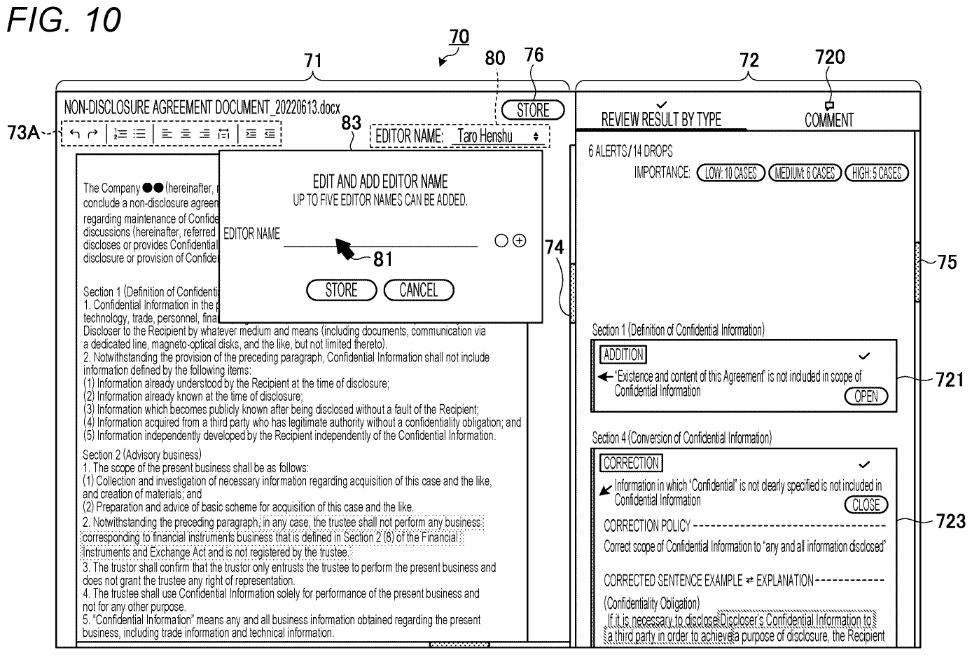

FIG. 10 is a diagram illustrating an example of an input area 83 of an editor name when “+edit/add editor name” in FIG. 9 is pressed on the document editing screen 70 of the present embodiment. In the present embodiment, as illustrated in FIG. 10, for example, up to five editor names can be added. At this time, a maximum number of editor names can be appropriately used by deleting or editing a preset editor name. Note that the number of editor names that can be added can be arbitrarily set other than five, and may be set without limitation of the number.

Note that the editor name may be individually set by a user of the terminal device T1 or may be set by a person other than the user. For example, the editor name may be added/edited by a vendor that provides a document editing support system. For example, an editor name that is considered to be often used in document creation, such as “proofreader”, “primary reviewer”, “approver”, or an organization name (for example, a company name or a company name and a department name) to which the user belongs, can be set in advance. In addition, the document editing support system may have, for example, a function that enables a user having administrator authority to collectively or individually set or add an editor name of another user in the same organization such that the editor names can be unified or set as a rule of the organization.

### Step S17

The editing processing unit 105 of the information processing device 10 of the present embodiment may update name information stored in a memory such as the main storage device 13 or the auxiliary storage device 15 to the name information edited in step S16. For example, in a deletion instruction, the editor name selected by the user is deleted from the name information. At this time, for example, the editing processing unit 105 may change the editor name selected by the user to an original user name or another registered editor name. In addition, for example, in an addition instruction, the editing processing unit 105 may add the editor name added by the user to the name information. In addition, for example, in an editing instruction, the editing processing unit 105 may update the editor name edited by the user in the name information.

### Step S18

The second control unit 40 of the terminal device T1 of the present embodiment may switch the name information transmitted from the information processing device 10 and stored in a memory such as the main storage device 23 or the auxiliary storage device 25 to the name information after the operation (addition, editing, or deletion) in step S16. Specifically, for example, a local storage of the browser unit 42 of the terminal device T1 may hold information indicating which number of editor name is selected among a plurality of editor names in the registered name information. The second control unit 40 may switch the selected name information by using, for example, a list of the registered name information transmitted from the information processing device 10 and data indicating the number of name information stored in the local storage of the browser unit 42 of the terminal device T1. As a result, the browser unit 42 can execute, for example, switching of the editor name in the name information. By this step, an editor name as a subject of the editing instruction can be determined.

### Step S19

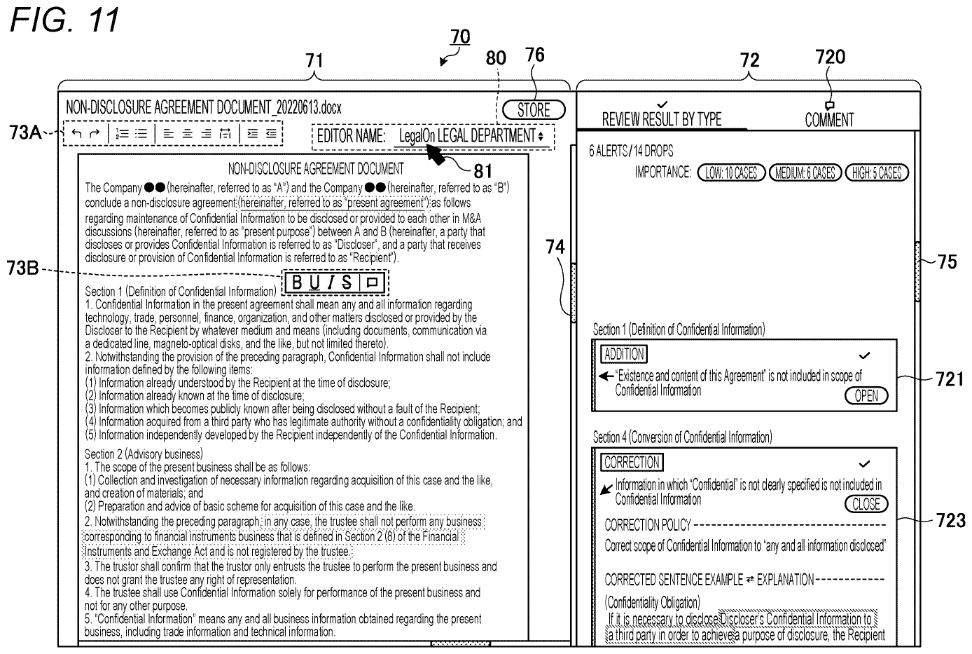

The terminal device T1 of the present embodiment may cause the browser unit 42 to display the name information (editor name) selected in step S16 on the sentence editing screen. As a result, the editing screen in which the name information has been switched may be displayed on the display device 30. The displayed editing screen may be, for example, a screen on which a review regarding document information can be input. FIG. 11 is a diagram illustrating an example in which the name information is changed from an editor name “Taro Henshu” indicating a name of an individual of a user illustrated in FIG. 7 to “LegalOn Legal Department” indicating a name of an organization on the document editing screen 70. As illustrated in FIG. 11, the changed name information may be clearly indicated on the document editing screen 70. As a result, the user can easily grasp the editor name in the current editing work.

### Step S20

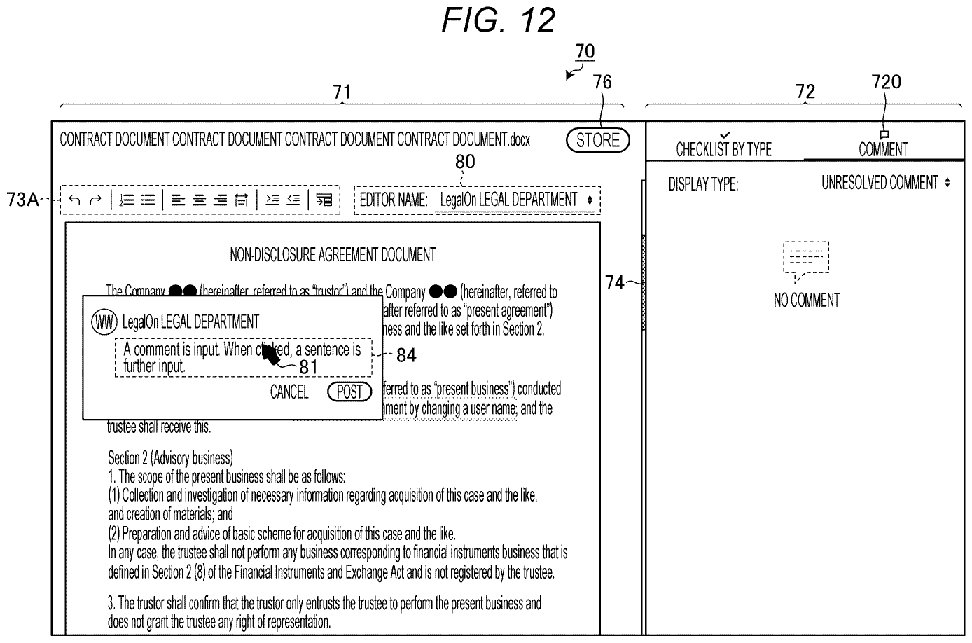

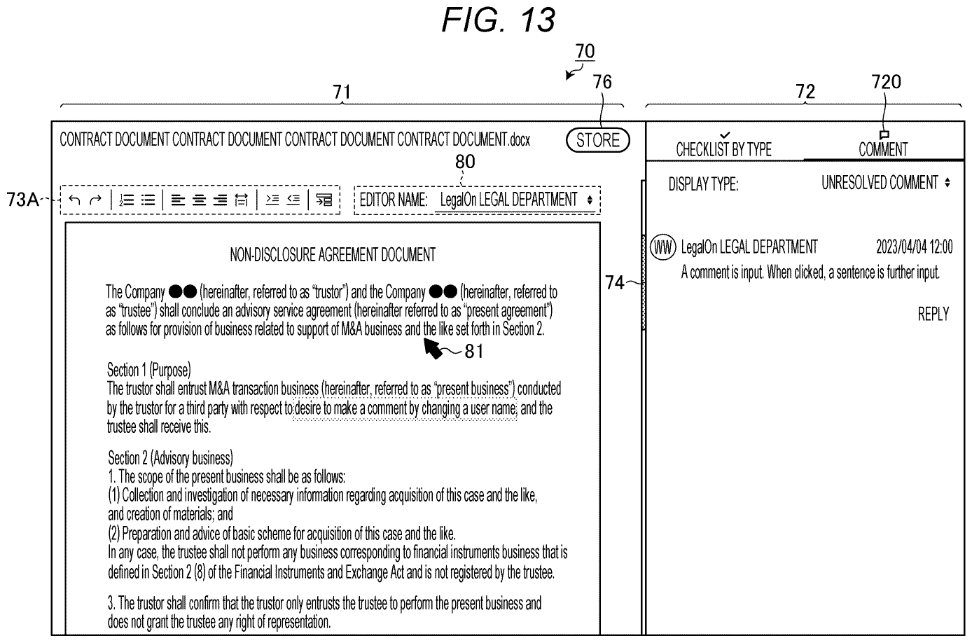

The browser unit 42 of the terminal device T1 of the present embodiment may receive various editing instructions (for example, operation of edit buttons of the tool bars 73A and 73B illustrated in FIG. 10 and an instruction by text data entry) input from the user. FIG. 12 is a diagram illustrating an example of an input area 84 of a comment regarding a place where a character string is dragged by the cursor 81 on the document editing screen 70 of the present embodiment. As illustrated in FIG. 12, the editor name “LegalOn Legal Department” may be displayed in the comment input area 84. FIG. 13 is a diagram illustrating an example of the document review area 72 when a comment is input on the document editing screen 70 of the present embodiment. As illustrated in FIG. 13, the editor name “LegalOn Legal Department” and a comment input time may be displayed in the comment in the document review area 72.

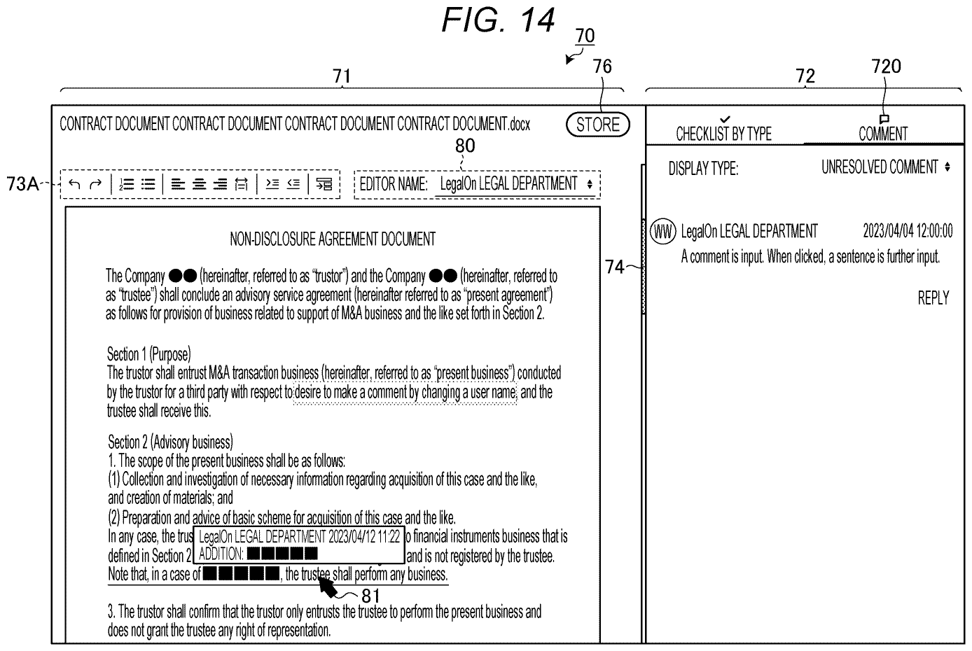

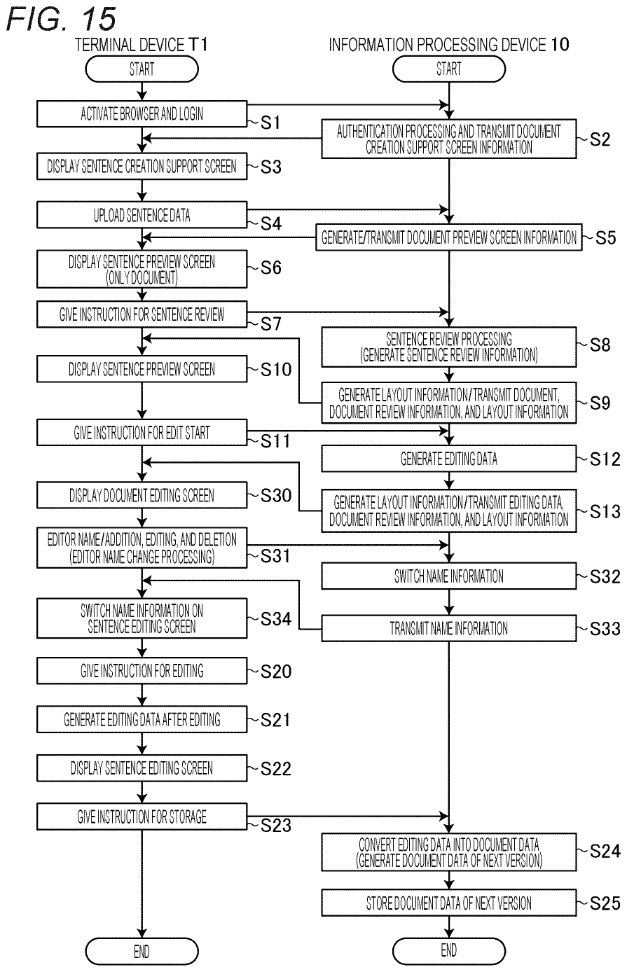

FIG. 14 is a diagram illustrating a display example at a time point when the cursor 81 is moved to an additional writing portion in the document editing area 71 of the present embodiment. As illustrated in FIG. 14, when the cursor 81 is moved to the additional writing portion (underlined portion in FIG. 14) in the document editing area 71, for example, the editor name “LegalOn Legal Department” related to the additional writing portion, a comment input time, a text at a head of the additional writing, and the like may be displayed.

### Step S21

The browser unit 42 of the terminal device T1 of the present embodiment may generate editing data reflecting an editing instruction in response to the editing instruction. For example, the browser unit 42 may generate editing information by associating an edited content edited on the editing screen by an instruction of the user for a document to be edited on the editing screen with an editor name (name information) at the time of inputting the edited content. That is, the editing information may include the name information.

### Step S22

The browser unit 42 of the terminal device T1 of the present embodiment may display the document editing screen 70 on the basis of the editing data, the document review information, and the layout information after the document editing processing.

### Step S23

The browser unit 42 of the terminal device T1 of the present embodiment may transmit a storage instruction (for example, an instruction by operation of the storage button 76 illustrated in FIGS. 7 and 9 to 14) input from the user to the information processing device 10. At this time, information regarding the editing data after the document editing processing may be also transmitted to the information processing device 10. That is, the browser unit 42 may transmit editing information including name information regarding editing to the information processing device 10.

### Step S24

The editing processing unit 105 of the information processing device 10 of the present embodiment may store, for example, document data based on the editing data received from the terminal device T1. For example, the editing processing unit 105 may convert the data format of the editing data to generate document data of a next version (that is, document data of a new version in the same format as the document uploaded in step S4). At this time, the editing processing unit 105 may add the editing information including the name information to the document information.

Note that the editing data that has been subjected to editing processing may be stored while being overwritten on the support target document data uploaded in step S4, or can be stored as another piece of data (for example, data of a different version). In addition, a URL that can access the edited document data may be issued without performing document data download processing. In addition, the terminal device that performs download may be a terminal device different from the terminal device that T1 performed editing, and the download may be performed by a user of another department that requests a legal department to examine a contract document or the other party in a contract negotiation.

### Step S25

The editing processing unit 105 of the information processing device 10 of the present embodiment may store document data for storage in the storage unit 109. At this time, editing information including name information may be given to sentence information in the document data for storage. That is, an edited content and an editor name who has edited the edited content may be associated with the sentence information of the present embodiment.

The terminal device T1 according to the present embodiment may include at least one processor 21, and the at least one processor 21 may give editing information including name information to document information and switch the name information on an editing screen of the document information. For example, the processor 21 in the terminal device T1 according to the present embodiment can select, edit, delete, and/or add an editor name different from a user who operates the editing screen according to an instruction of the user. In addition, the processor 21 in the terminal device T1 according to the present embodiment may switch the name information from a user name to an editor name. Note that “on the editing screen” may include that an area for editing a document and a display for switching the name information are displayed simultaneously, for example, side by side. In addition, “on the editing screen” may include a case where an area for editing a document and a display for switching name information are partially superimposed and displayed by a pop-up or the like.

As a result, according to the present embodiment, on the editing screen, the user can easily change the editor name according to an edited content. Therefore, according to the present embodiment, it is possible to achieve a technique in which an operation load on a user is lighter than that in related art when supporting document creation on a web browser. As a result, it is possible to flexibly create a document, and thus, it is possible to appropriately exchange information with an organization to which the user belongs, a third party, or the like by using a created document to which a comment is added.

In addition, in the terminal device T1 according to the present embodiment, the editing information may be generated by associating an edited content edited on an editing screen by an instruction of the user for a document to be edited on the editing screen with an editor name at the time of inputting the edited content. As a result, according to the information processing device 10 according to the present embodiment, the editor name can be left also in document creation software by giving the editing information included in association with the edited content using the changed editor name as name information to the document information. Therefore, according to the terminal device T1 according to the present embodiment, it is possible to store and manage a document edited while referring to document review information on a web browser in the same data format as the support target document.

In addition, in the terminal device T1 according to the present embodiment, the document information may be legal document data regarding a contract or document data regarding a legal document, and the editing screen may be a screen on which a review regarding the document information can be input. As a result, according to the terminal device T1 according to the present embodiment, the user can edit the editing data while referring to, for example, document review information displayed in association with the editing data in units of articles or in units of paragraphs in position.

In addition, in the terminal device T1 according to the present embodiment, the at least one processor 21 may cause the display device 30 to display an editor name used in the previous editing operation or a user name on the editing screen as default name information. As a result, according to the terminal device T1 according to the embodiment, when the user logs in, it is possible to execute editing work by taking over the editor name at the time of the previous editing.

From the above, according to the terminal device T1 according to the embodiment, it is possible to change the editor name in a state where a screen to be edited is displayed to a user, and for example, it is possible to create and set an arbitrary editor name while confirming what editor name appears in a contract document. In addition, according to the terminal device T1 according to the embodiment, a user can set an editor name associated with a correction history and a comment to an arbitrary name. From these, according to the terminal device T1 according to the embodiment, by reducing effort of a user related to a change of the editor name and time related to the change, and displaying the editor name on an editing screen all the time, it is possible to prevent in advance an error such as forgetting to change the editor name when the date changes.

### First Modification

In the present modification, after execution of the storage instruction in step S23 in the document creation support processing, the editor name may be changed, and the editing processing may be executed again. At this time, in the document creation support processing, the processing of step S16 may be executed following the processing of step S23. In the display of the document editing screen 70 by the display device 30, for example, when an end of editing work such as an instruction to end a browser is input by a user, the document creation support processing may end. On the other hand, in step S16, when the editor name change processing is executed on the document editing screen 70 displayed on the display device 30, the processing of S17 and subsequent steps may be repeated.

According to the information processing device 10 according to First Modification of the present embodiment, a user can change an editor name. As a result, according to the terminal device T1 according to First Modification, it is possible to reduce effort of a user related to a change of the editor name and time related to the change in each of a plurality of editing instructions. According to the terminal device T1 according to First Modification of the present embodiment, for example, a document X may be edited with an editor name A and the document X edited with the editor name A is sent to a client, and then the document X that has obtained a review back can be edited with an editor name B. That is, according to the terminal device T1 according to First Modification of the present embodiment, the editor name A at the time of the previous editing and the editor name B at the time of the current editing coexist, whereby the user can easily grasp at which stage of a contract document review correction has been made.

### Second Modification

In the present modification, a plurality of users using a plurality of terminal devices T1 to TN may simultaneously edit one piece of document information with the same editor name. At this time, the document creation support processing illustrated in FIG. 8 may be executed between each of the plurality of terminal devices T1 to TN and one information processing device 10. In the present modification, when the same editor name is selected by a plurality of users, editing information may be generated in association with an edited content according to an editing instruction using the selected same editor name as name information. For example, the editing processing unit 105 may integrate edited contents edited with the same editor name in the browser units 42 of the plurality of terminal devices T1 to TN. The editing processing unit 105 may generate editing information by associating the edited content with name information corresponding to the same editor name. Since other processing is similar to that of the embodiment, description thereof is omitted.

According to the terminal device T1 according to Second Modification of the present embodiment, when editing work is simultaneously executed by a plurality of users with the same editor name, it is possible to integrate the plurality of pieces of editing work to generate editing information with one editor name. As a result, according to the information processing device 10 according to Second Modification, it is possible to execute editing work by a plurality of users with one editor name, and to reduce the editing work, that is, to improve efficiency of the editing work. In addition, according to the terminal device T1 according to Second Modification of the present embodiment, the same editor name can be used even when a plurality of persons in charge review a contract document (for example, a primary review or a secondary review). Therefore, according to the terminal device T1 according to Second Modification of the present embodiment, it is possible to reduce necessity of work of integrating or unifying names of editing information of a document to be transmitted to the other party in a contract negotiation. In addition, according to the terminal device T1 according to Second Modification of the present embodiment, even when a person in charge of a document review is changed, it is possible to smoothly hand over a review and the like to another person in charge by using the same editor name or the like. From these, according to the terminal device T1 according to Second Modification of the present embodiment, it is possible to improve ease of handling document information.

### Third Modification

In the present modification, the information processing device 10 may implement switching of name information regarding selection, editing, addition, and deletion of an editor name in a flow of document creation support processing. FIG. 15 is a flowchart illustrating a flow of document creation support processing according to Third Modification of the present embodiment. In FIG. 15, the same processing as the document creation support processing illustrated in FIG. 6 may be indicated by the same step number. Hereinafter, in FIG. 15, a processing procedure different from that in FIG. 8 will be described.

### Step S30

The browser unit 42 of the terminal device T1 may display the document editing screen 70 on the basis of the editing data, the document review information, the layout information, and the information for executing the document editing processing received from the information processing device 10. Note that, on the document editing screen 70, for example, the document review information and the editing data as illustrated in FIG. 7 may be displayed in a form in which positions thereof are associated with each other.

### Step S31

The browser unit 42 of the terminal device T1 may execute selection, editing, and/or deletion of an editor name (editor name change processing) according to an instruction of a user via the input device 31. Note that, when the editor name is not selected, edited, and/or deleted, the processing of step S20 may be executed. At this time, in the name information, for example, a name of a logged-in user may be registered as the editor name.

### Step S32

The first control unit 107 of the information processing device 10 may switch the name information regarding editing to the selected editor name. For example, the first control unit 107 of the information processing device 10 may select, edit, and/or delete an editor name different from a user who operates an editing screen according to an instruction of the user. At this time, the first control unit 107 of the information processing device 10 may switch the name information from a user name to an editor name. Note that the name information may be switched by the editing processing unit 105 of the information processing device 10. The first control unit 107 of the information processing device 10 may add the name information to the additional information in the storage unit 109. By this step, an editor name as a subject of the editing instruction may be determined.

### Step S33

The first control unit 107 of the information processing device 10 may transmit the selected name information to the terminal device T1 As a result, the first control unit 107 of the information processing device 10 may switch the name information on an editing screen of the document information.

### Step S34

The browser unit 42 of the terminal device T1 may switch the name information on the editing screen on the basis of the name information received from the information processing device 10. As a result, the editing screen in which the name information has been switched may be displayed on the display device 30. The displayed editing screen may be, for example, a screen on which a review regarding document information can be input. FIG. 11 is a diagram illustrating an example in which name information may be changed from an editor name “Taro Henshu” illustrated in FIG. 7 to “LegalOn Legal Department” on the document editing screen 70. As illustrated in FIG. 11, the changed name information may be clearly indicated on the document editing screen 70. As a result, the user can easily grasp the editor name in the current editing work.

The information processing device 10 according to Third Modification of the present embodiment may include at least one processor 21, and the at least one processor 21 gives editing information including name information to document information and switches the name information on an editing screen of the document information. For example, the processor 21 in the information processing device 10 according to Third Modification of the present embodiment can select, edit, delete, and/or add an editor name different from a user who operates the editing screen according to an instruction of the user. In addition, the processor 21 in the information processing device 10 according to Third Modification of the present embodiment switches the name information from the name of the user to the editor name. In addition, in the information processing device 10 according to Third Modification of the present embodiment, editing information may be generated by associating an edited content edited on an editing screen by an instruction of the user for a document to be edited on the editing screen with an editor name at the time of inputting the edited content. In addition, in the information processing device 10 according to Third Modification of the present embodiment, the document information may be legal document data regarding a contract or document data regarding a legal document, and the editing screen may be a screen on which a review regarding the document information can be input. In addition, in the information processing device 10 according to Third Modification of the present embodiment, the at least one processor 21 may cause the terminal device T1 to display an editor name used in the previous editing operation or a user name on the editing screen as default name information. As a result, according to the information processing device 10 according to Third Modification of the present embodiment, when the user logs in, it is possible to execute editing work by taking over the editor name at the time of the previous editing. Since an effect of the present modification may be similar to that of the embodiment, description thereof is omitted.

When the technical idea in the embodiment is achieved by an information processing method, the information processing method may add editing information including name information to document information, and switch the name information on an editing screen of the document information. Since a procedure and an effect of document creation support processing executed by the information processing method may be similar to those of the embodiment, description thereof is omitted.

When the technical idea in the embodiment is achieved by an information processing program, the information processing program may cause a computer to implement a function of giving editing information including name information to document information, and a function of switching the name information on an editing screen of the document information.

For example, information processing can also be implemented by installing an information processing program in a computer in a server device (processing device) or the like connectable to the plurality of terminal devices T1 to TN and developing the information processing program on a memory. At this time, the information processing program that can cause the computer to execute the information processing can also be distributed by being stored in a storage medium such as a magnetic disk (hard disk or the like), an optical disk (CD-ROM, DVD, or the like), or a semiconductor memory. Since a procedure and an effect of document creation support processing executed by the information processing program are similar to those of the embodiment, description thereof is omitted.

According to at least one embodiment described above, it is possible to provide a technique in which an operation load on a user is lighter than that in related art. As a result, according to at least one embodiment described above, it is possible to provide a technique in which an operation load on a user is lighter and convenience is higher than those in related art when supporting document creation on a web browser. For example, according to at least one embodiment described above, in a specific example in a case where it is desired to change name information or a use case in the above description or the like (in a case where it is desired to provide a comment as an organization such as a company or a department, in a case where it is desired to selectively use a comment between the outside of the company where it is not desired to specify an individual and the inside of the company where it is desired to specify an individual, in a case where it is desired to provide different type of information depending on a comment (for example, a date or a version number), or the like), the name information is made different from the user name without using a user name as the name information, whereby the name information can be easily changed without being bound by environment setting or company rules. In addition, according to at least one embodiment described above, for example, depending on a company that performs a review, the name information can be easily changed even when a user name cannot be easily changed due to a rule of the company.

Although the embodiments of the present disclosure have been described in detail above, these embodiments have been presented as examples, and are not intended to be limited to individual embodiments. The embodiments can be modified by various additions, changes, replacements, partial deletions, combinations, and the like without departing from the technical idea of the present invention. These embodiments and modifications thereof are included in the invention described in the claims and an equivalent scope thereof.

What is claimed is:

1. A terminal device comprising at least one processor, wherein
the at least one processor
gives editing information including name information to document information, and
switches the name information on an editing screen of the document information.

2. The terminal device according to claim 1, wherein
the at least one processor
can select, edit, delete, and/or add an editor name different from a user who operates the editing screen according to an instruction of the user.

3. The terminal device according to claim 1, wherein
the at least one processor
switches the name information from a user name to an editor name.

4. The terminal device according to claim 3, wherein
the editing information is generated by associating an edited content edited on the editing screen by an instruction of the user for a document to be edited on the editing screen with the editor name at the time of inputting the edited content.

5. The terminal device according to claim 3, wherein
the at least one processor causes a display device to display an editor name used in the previous editing operation or the user name on the editing screen as default name information.

6. The terminal device according to claim 1, wherein
the document information is legal document data regarding a contract or document data regarding a legal document, and
the editing screen is a screen on which a review regarding the document information can be input.

7. The terminal device according to claim 1, wherein
the editing information is a change history or a comment of the document information.

8. An information processing method comprising:
giving editing information including name information to document information; and
switching the name information on an editing screen of the document information.

9. A non-transitory computer-readable storage medium storing instructions that, when executed by one or more processors, cause the one or more processors to perform operations comprising:
giving editing information including name information to document information; and
switching the name information on an editing screen of the document information.
